(19) United States
(12) Patent Application Publication
(10) Pub. No.: US 2015/0171431 A1
(43) Pub. Date: Jun. 18, 2015

(54) SECONDARY BATTERY AND METHOD OF MANUFACTURING THE SAME

(71) Applicant: Samsung Electronics Co., Ltd., Suwon-si (KR)

(72) Inventors: Takanobu YAMADA, Yokohama-city (JP); Yuichi AIHARA, Yokohama-city (JP); Satoshi FUJIKI, Yokohama-city (JP)

(21) Appl. No.: 14/571,488

(22) Filed: Dec. 16, 2014

(30) Foreign Application Priority Data
Dec. 17, 2013 (JP) 2013-260395
Nov. 19, 2014 (KR) 10-2014-0161629

(51) Int. Cl. H01M 4/70; H01M 10/0525; H01M 10/0562; H01M 10/04; H01M 10/058

(52) U.S. Cl. CPC H01M 4/70; H01M 10/04; H01M 10/058; H01M 10/0562; H01M 10/0525; H01M 2300/0068

(57) ABSTRACT

A secondary battery including a first electrode structure including a first electrode current collector, the first electrode current collector including a first electrode layer forming region and a first electrode layer non-forming region on each surface of the first electrode current collector, a second electrode structure including a second electrode current collector, the second electrode current collector including a second electrode layer forming region and a second electrode layer non-forming region on each surface of the second electrode current collector, wherein the first and second electrode layer non-forming regions respectively include first and second electrode current collector tab coupling regions in an interior portion of each of the first and second electrode layer forming regions, and wherein the first electrode structure, the second electrode structure, and an electrolyte layer disposed between the first electrode structure and the second electrode structure are enclosed with an exterior body.

### RELATED APPLICATIONS

This application claims priority to and the benefit of Japanese Patent Application No. 2013-260395, filed on Dec. 17, 2013, and Korean Patent Application No. 10-2014-0161629, filed on Nov. 19, 2014, in the Korean Intellectual Property Office, and all the benefits accruing therefrom under 35 U.S.C. §119, the contents of which are incorporated herein in their entirety by reference.

### BACKGROUND

1. Field

The present disclosure relates to a secondary battery and a method of manufacturing the secondary battery.

2. Description of the Related Art

A secondary battery is a device that may be repeatedly charged and discharged by moving charges through an electrolyte, which is disposed between a cathode and an anode.

Recently, a secondary battery, for example, a lithium ion secondary battery, has a structure that is enclosed within an exterior body formed of a material such as an aluminum laminate film. Using the aluminum laminate film a thin battery can be provided.

In general, a cell of a lithium ion secondary battery has a structure including a cathode structure including a cathode layer on a surface of a cathode current collector and a cathode current collector tab coupled to the cathode layer, an anode structure including an anode layer on a surface of an anode current collector and an anode current collector tab coupled to the anode layer, and an electrolyte layer disposed between the cathode structure and the anode structure. When stacking each layer, the cathode current collector tab and the anode current collector tab may be respectively coupled to the respective adjacent cathode structure and anode structure that are separated from each other.

In order to increase energy density of lithium ion secondary batteries, a sufficiently large area electrode layer is used. In order to provide as large of an area of the electrode layer as possible, an electrode current collector tab coupling region may be mounted and protrude from an electrode layer forming region.

However, when the lithium ion secondary battery has such a structure, in which the electrode current collector tab coupling region protrudes from the electrode forming region, the electrode current collector tab coupling region may be easily fractured due to a pressure treatment that is performed during manufacture of the battery. In addition, when an exterior of the structure is enclosed with an exterior body, an increase in energy density of the lithium ion secondary battery may be suppressed.

Therefore, there remains a need for a secondary battery having a structure that prevents an electrode current collector tab coupling portion from being fractured and which provides improved energy density of the battery.

### SUMMARY

Provided is a secondary battery that may prevent fractures on an electrode current collector tab coupling region and may have improved production efficiency and energy density.

Provided is a method of manufacturing the secondary battery.

Additional aspects will be set forth in part in the description which follows and, in part, will be apparent from the description.

According to an aspect, a secondary battery includes a first electrode structure including a first electrode current collector, the first electrode current collector including a first electrode layer forming region and a first electrode layer non-forming region on each surface of the first electrode current collector, a second electrode structure including a second electrode current collector, the second electrode current collector including a second electrode layer forming region and a second electrode layer non-forming region on each surface of the second electrode current collector, wherein the first and second electrode layer non-forming regions respectively include first and second electrode current collector tab coupling regions in an interior portion of each of the electrode layer forming regions, and wherein the first electrode structure, the second electrode structure, and an electrolyte layer are disposed between the first electrode structure and the second electrode structure and are disposed in an exterior body.

According to an aspect, a method of manufacturing a secondary battery includes coating a surface of a first electrode current collector with a first electrode coating solution including a first electrode active material to form a first electrode layer and an electrode layer non-forming region including a first electrode current collector tab coupling region in an interior of the first electrode layer; coating a surface of a second electrode current collector with a second electrode coating solution including a second electrode active material to form a second electrode layer and a second electrode layer non-forming region including a second electrode current collector tab coupling region in an interior of the second electrode layer; coupling the first and second electrode current collector tab coupling regions to first and second electrode current collector tabs, respectively, to manufacture a first electrode structure and a second electrode structure; disposing an electrolyte layer between the first electrode structure and the second electrode structure; enclosing the first electrode structure, the second electrode structure, and the electrolyte layer with an exterior body, and then pressure treating the first electrode structure, the second electrode structure, and the electrolyte layer to integrate the first electrode structure, the second electrode structure, and the electrolyte layer to manufacture the secondary battery.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1A is a schematic plan view illustrating an embodiment of an electrode structure 100 prepared in the Example;

FIG. 1B is a schematic plan view illustrating an embodiment of the electrode structure 100 enclosed by an exterior body 106 and a sealant 105, after coupling an electrode current collector tab 104 to an electrode current collector tab coupling region 102 (an electrode layer non-forming region of an electrode current collector 103);

FIG. 2A is a schematic plan view illustrating an embodiment of an electrode structure 200 prepared in the Comparative Example;

FIG. 2B is a schematic plan view illustrating an embodiment of the electrode structure 200 enclosed by an exterior body 206 and a sealant 205, after coupling an electrode current collector tab 204 to an electrode current collector tab coupling region 202 (an electrode layer non-forming region of an electrode current collector 203); and

FIG. 3 is a schematic cross-sectional view of an embodiment of an all solid battery.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects. As used herein, the term “and/or” includes any and all combinations of one or more of the associated listed items. “Or” means “and/or.” Expressions such as “at least one of,” when preceding a list of elements, modify the entire list of elements and do not modify the individual elements of the list. The inventive concept will now be described more fully hereinafter with reference to the accompanying drawings, in which exemplary embodiments of the inventive concept are shown. The inventive concept may, however, be embodied in many different forms and should not be construed as being limited to the embodiments set forth herein; rather these embodiments are provided so that this disclosure will be thorough and complete, and will fully convey the concept of the inventive concept to one of ordinary skill in the art. Thus, the scope of the inventive concept is defined by the following claims.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising” when used in this specification, specify the presence of stated elements, steps, actions, and/or devices, but do not preclude the presence or addition of one or more other elements, steps, actions, and/or devices. It will be understood that, although the terms first, second, etc. may be used herein to describe various elements, these elements should not be limited by these terms. These terms are only used to distinguish one element from another.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer or section from another element, component, region, layer, or section. Thus, “a first element,” “component,” “region,” “layer,” or “section” discussed below could be termed a second element, component, region, layer, or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The terms a “first electrode structure” and a “second electrode structure” used herein refer to structures that are opposite to each other, that is, a “cathode structure” may be opposite an “anode structure,” and an “anode structure” may be opposite an a “cathode structure”.

The term an “electrode current collector” used herein refers to a “first electrode current collector” or a “second electrode current collector,” each of which may be included in the “first electrode structure” or the “second electrode structure,” respectively.

The term an “electrode layer forming region” used herein refers to a region where an electrode active material is applied on a surface of the electrode current collector and includes a “first electrode layer forming region” and/or a “second electrode layer forming region.”

The term an “electrode layer non-forming region” used herein refers to a region where an electrode active material is not applied on a surface of the electrode current collector and includes a “first electrode layer non-forming region” and/or a “second electrode layer non-forming region.”

The term “on a surface” used herein refers to “on a surface and in direct contact” or “on a single layer or a plurality of layers such as an adhesion layer and not in direct contact with a surface.”

The term an “outer (most) portion” used herein refers to the outer (most) edge of a circular or polygonal shape.

Hereinafter, a secondary battery and a method of manufacturing the secondary battery according to an exemplary embodiment will be disclosed in further detail. A lithium ion secondary battery as an example of the secondary battery will be disclosed in further detail.

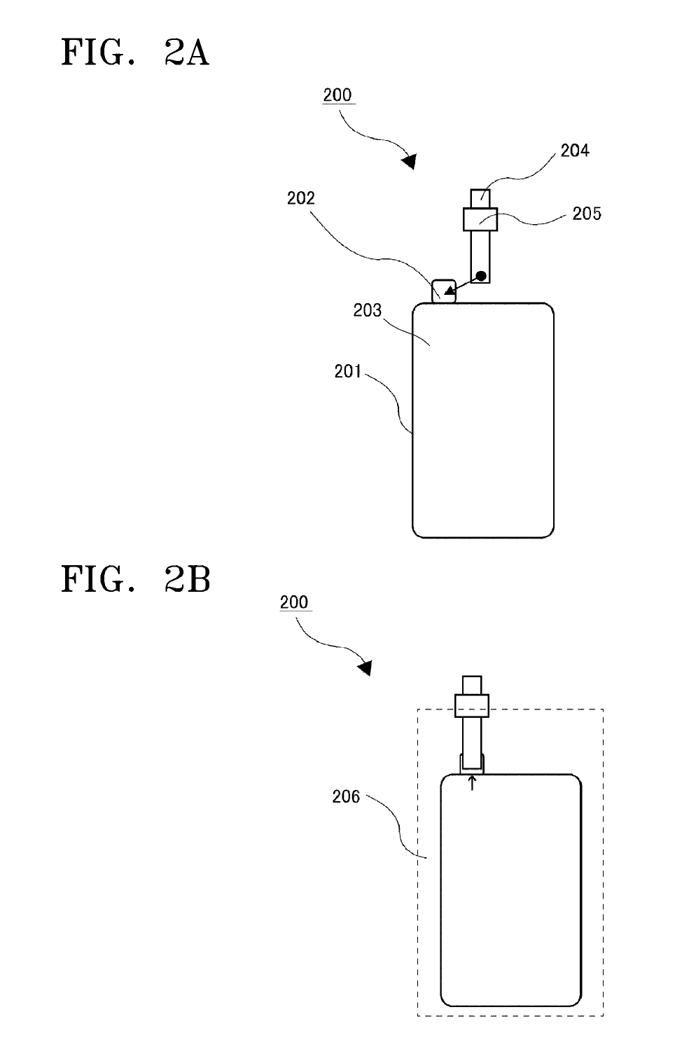

FIG. 2A is a schematic plan view illustrating an embodiment of an electrode structure 200 prepared in the Comparative Example. FIG. 2B is a schematic plan view illustrating an embodiment of the electrode structure 200 enclosed by an exterior body 206 and a sealant 205 after coupling an electrode current collector tab 204 to an electrode current collector tab coupling region 202 (an electrode layer non-forming region of an electrode current collector 203).

Shown in FIGS. 2A and 2B, is electrode structure 200, electrode layer 201, which is disposed on the electrode current collector 203, and electrode current collector tab coupling region 202. The electrode structure 200 may be a first electrode structure or a second electrode structure.

As shown in FIG. 2B, an end of the electrode current collector tab 204 may be exposed to the outside of the exterior body 206 in order to be connected to a lead, which is not shown in the drawing. In FIG. 2B, only the electrode structure 200 is illustrated for convenience of description, but, in a practical lithium ion secondary battery, a cell comprising two electrode structures and an electrolyte layer is enclosed with an exterior body. Therefore, the electrode current collector tab 204 and another electrode current collector tab (not shown), that are separated from each other, may be enclosed with the exterior body 206 and exposed to the outside.

However, as shown in FIGS. 2A and 2B, the electrode structure 200 of the Comparative Example has a structure of which the electrode current collector tab coupling region 202 protrudes from an electrode layer forming region, and thus the electrode current collector tab coupling region 202 (the electrode layer non-forming region of the electrode current collector 203) may easily fracture while performing a pressure treatment during manufacture of a battery. Moreover, when the electrode structure 200 of Comparative Example is enclosed with the exterior body 206, a size of the exterior body 206 increases, and thus energy density may be decreased.

### Secondary Battery: Lithium Ion Secondary Battery

According to an aspect, a secondary battery may include an electrode structure comprising an electrode layer forming region and an electrode layer non-forming region on each surface of electrode current collectors of a first electrode structure and a second electrode structure, wherein the electrode layer non-forming region of each electrode current collector includes an electrode current collector tab coupling region in an interior of the electrode layer forming region, and the first electrode structure, the second electrode structure, and an electrolyte layer disposed between the first electrode structure and the second electrode structure may be enclosed within an exterior body and integrated by performing a pressure treatment.

In an embodiment, the secondary battery comprises a first electrode structure comprising a first electrode current collector, the first electrode current collector comprising a first electrode layer forming region and a first electrode layer non-forming region on each surface of the first electrode current collector, and a second electrode structure comprising a second electrode current collector, the second electrode current collector comprising a second electrode layer forming region and a second electrode layer non-forming region on each surface of the second electrode current collector. The first and second electrode layer non-forming regions may respectively comprise first and second electrode current collector tab coupling regions in an interior portion of each of the first and second electrode layer forming regions. Also, the first electrode structure, the second electrode structure, and an electrolyte layer may be disposed between the first electrode structure and the second electrode structure and be disposed in an exterior body.

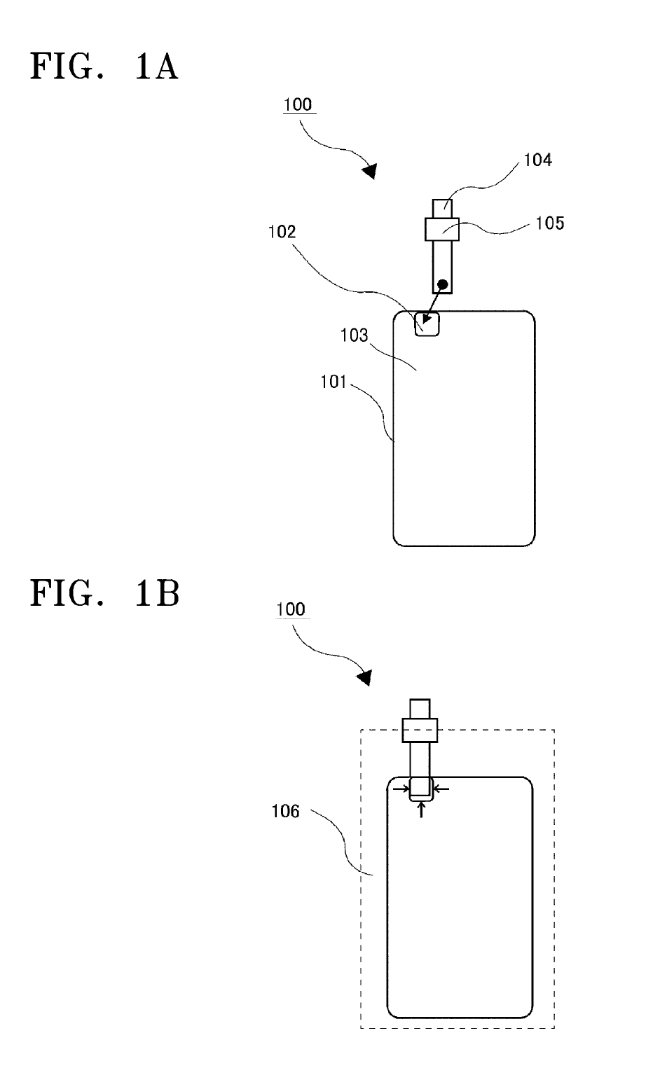

The first electrode structure and the second electrode structure will be further described with reference to FIGS. 1A and 1B.

FIG. 1A is a schematic plan view illustrating an electrode structure prepared in the Example. FIG. 1B is a schematic plan view illustrating an electrode structure 100 enclosed by an exterior body 106 and a sealant 105, after coupling an electrode current collector tab 104 to an electrode current collector tab coupling region 102 (an electrode layer non-forming region of an electrode current collector 103).

In FIGS. 1A and 1B, shown is an electrode structure 100, and an electrode layer 101 formed on the electrode current collector 103. Also shown is an electrode current collector tab coupling region 102. The electrode current collector tab coupling region 102 is on a surface of the electrode current collector 103 of the electrode layer non-forming region, and thus the electrode current collector 103 is exposed to the outside. However, the electrode current collector tab coupling region 102 according to an embodiment does not protrude with respect to the surface of the electrode current collector 103. The first electrode structure and the second electrode structure may both have a structure as described above.

A cell may be assembled after disposing the electrolyte layer (not shown) between the first electrode structure and the second electrode structure. The cell may be enclosed with the exterior body 106, and the exterior body 106 may be sealed by the sealant 105. FIG. 1B illustrates an embodiment of a cell sealed by the exterior body 106 and the sealant 105. In FIG. 1B, only the electrode structure 100, for example, the first electrode structure, is illustrated in order to simplify explanation. However, in an actual secondary battery, for example, in a lithium ion secondary battery, a second electrode structure is stacked in an interior of an exterior body opposite the first electrode structure, e.g., to provide a cathode structure opposite an anode structure. Therefore, an electrode current collector tab of the second electrode structure is exposed to the outside at a location separated from the electrode current collector tab 104 of the second electrode structure.

The electrode current collector tab coupling region 102 may be formed at any suitable location within the electrode layer forming region. However, when the electrode current collector tab coupling region 102 is too broad, energy density may be decreased due to lack of electrode layer 101. Therefore, an area of the electrode current collector tab coupling region 102 may be minimized so as to provide a larger area for the electrode layer 101.

As shown in FIGS. 1A and 1B, the electrode current collector tab coupling region 102 may be located in an outermost portion of the electrode layer forming region. A shape of the electrode current collector tab coupling region 102 may have a shape of a circle or polygon. When the electrode current collector tab coupling region 102 is in a shape of a polygon, the electrode current collector tab coupling region 102 may be have a shape of a triangle or rectangle. In terms of ease of manufacture, the electrode current collector tab coupling region 102 may be in a shape of a rectangle.

Thus, two or more directions of the outer circumference of the electrode current collector tab coupling region 102 may be surrounded by the electrode layer 101. Therefore, an outer portion of the electrode current collector tab coupling region 102 (the electrode layer non-forming region of the electrode current collector 103) may be connected to and supported by the electrode layer forming region in two or more directions that are parallel with a surface direction. The “surface direction” refers to a horizontal surface or vertical surface of the electrode current collector 103.

As a result, fracture of the electrode current collector tab coupling region 102 (the electrode layer non-forming region of the electrode current collector 103) may be reduced or avoided even when a pressure treatment is performed to the electrode current collector tab coupling region 102 (the electrode layer non-forming region of the electrode current collector 103) to integrate each layer. Accordingly, the secondary battery according to an embodiment, for example, the lithium ion secondary battery may have improved pressure resistance. More specifically, even when a pressure treatment is performed in a range of about 294 megapascals (MPa) to about 980 MPa to the lithium ion secondary battery, the electrode current collector tab coupling region 102 (in the electrode layer non-forming region of the electrode current collector 103) may not be fractured. As a result, production efficiency of the lithium ion secondary battery may be improved by modifying the electrode structure 100 as shown.

Referring to FIG. 1B, the electrode current collector tab coupling region 102 may be in a shape of a rectangle. The outer portion of the electrode current collector tab coupling region 102 may be connected to and supported by the electrode layer forming region in three directions that are parallel with the surface direction. Arrows illustrated in FIG. 1B indicate directions supporting the electrode current collector tab 104 by the electrode layer 101. In some embodiments, the electrode current collector tab coupling region 102 may be in a shape of a triangle, and then the electrode current collector tab coupling region 102 may be connected and thus supported in two directions that are parallel with the surface direction. In some embodiments, the electrode current collector tab coupling region 102 may be in a shape of a hexagon, and then the electrode current collector tab coupling region 102 may be connected and supported in five directions that are parallel with the surface direction. In other words, when the electrode current collector tab coupling region 102 is formed in a shape of an n-polygon, the electrode current collector tab coupling region 102 may be connected supported by the electrode layer forming region in (n−1) directions that are parallel with the surface direction. In addition, when the electrode current collector tab 104 has a corresponding shape and is coupled to the electrode current collector tab coupling region 102, the electrode current collector tab 104 may be connected to and supported by the electrode layer 101 in (n−1) directions that are parallel with the surface direction.

In FIG. 1B, the electrode structure 100 may include the electrode current collector tab 104, and the electrode current collector tab 104 may be coupled to the electrode current collector tab coupling region 102, and an end of the electrode current collector tab 104 may protrude from the electrode current collector. The electrode current collector tab 104 may be connected to and supported in two or more directions that are parallel with the surface direction by the electrode layer 101 formed in the electrode layer forming region. Therefore, the electrode current collector tab coupling region 102 becomes larger so that the electrode current collector tab coupling region 102 may be formed even in an interior of the electrode layer forming region.

As a result, an area of the electrode current collector tab coupling region 102 may be in a range of about 0.8% to about 1.3% with respect to the total area of the electrode current collector 103. When the area of the electrode current collector tab coupling region 102 is 1.3% or greater, that is, an area of the electrode layer is 98.7% or less, energy density of the lithium ion secondary battery may be decreased. When the area of the electrode layer is 99.2% or greater, the area of the electrode current collector tab coupling region 102 is 0.8% or less. When the area of the electrode current collector tab coupling region 102 is 0.8% or less, a coupling area of the electrode current collector tab 104 decreases, and thus coupling capability decreases, and the electrode current collector tab 104 may fracture.

A secondary battery may have a shape without a protruding portion by forming the electrode current collector tab coupling region 102 according to the aspect described above. The electrode structure 100 may have, compared to the electrode structure having a protruding portion according to FIGS. 2A and 2B, a weight decrease in a range of about 5% to about 15%, and volume decrease in a range of about 3% to about 5%. In this regard, a usage amount of the exterior body may be reduced, and the reduction of energy density due to a resistance of the exterior body may also be suppressed. Therefore, though the area of the electrode layer decreases, the reduction of energy density that results in formation of the electrode structure may be offset due to the reduction of the usage amount of the exterior body, consequentially improving the energy density of the lithium ion secondary battery. The lithium ion secondary battery may be used in mobile devices, hybrid vehicles, electric vehicles or electrically-drive tools.

The first electrode structure and the second electrode structure may have the same structure except that each of the electrode layers has different components. Any of the first electrode structure and the second electrode structure may include a cathode active material in the electrode layer thereof, and the other electrode structure may include an anode active material in the electrode layer thereof. Hereinafter, for convenience, the first electrode structure will be described as a cathode structure, and the second electrode structure will be described as an anode structure.

A cathode layer forming the cathode structure contains a cathode active material and a binder, and the cathode layer is formed on a surface of a cathode current collector.

The cathode current collector may be provided using a conductive material, for example, aluminum, stainless steel, or nickel-plated steel.

The cathode active material may be any suitable compound capable of reversible intercalation and deintercalation of lithium ions. The compound capable of reversible intercalation and deintercalation of lithium ions may be, not particularly limited to, at least one selected from compounds represented by LiₐA_{1-b}B′_{b}D′₂ (where 0.90≦a≦1.8, and 0≦b≦0.5); LiₐE_{1-b}B′_{b}O_{2-c}D′_{c} (where 0.90≦a≦1.8, 0≦b≦0.5, and 0≦c≧0.05); LiE_{2-b}B′_{b}O_{4-c}D′_{c} (where 0≦b≦0.5, and 0≦c≦0.05); LiₐNi_{1-b-c}Co_{b}B′_{c}D′_{α} (where 0.90≦a≦1.8, 0≦b≦0.5, 0≦c≦0.05, and 0<α≦2); LiₐNi_{1-b-c}Co_{b}B′_{c}O_{2-α}F′α (where 0.90≦a≦1.8, 0≦b≦0.5, 0≦c≦0.05, and 0<α<2); LiₐNi_{1-b-c}Co_{b}B′_{c}O_{2-α}F′_{α} (where 0.90≦a≦1.8, 0≦b≦0.5, 0≦c≦0.05, and 0<α<2); LiₐNi_{1-b-c}Mn_{b}B′_{c}D_{α} (where 0.90≦a≦1.8, 0≦b≦0.5, 0≦c≦0.05, and 0<α≦2); LiₐNi_{1-b-c}Mn_{b}B′_{c}O_{2-α}F′_{α} (where 0.90≦a≦1.8, 0≦b≦0.5, 0≦c≦0.05, and 0<α<2); LiₐNi_{1-b-c}Mn_{b}B′_{c}O_{2-α}F′₂ (where 0.90≦a≦1.8, 0≦b≦0.5, 0≦c≦0.05, and 0<α<2); LiₐNi_{b}E_{c}G_{d}O₂ (where 0.90≦a≦1.8, 0≦b≦0.9, 0≦c≦0.5, and 0.001≦d≦0.1); LiₐNi_{b}Co_{c}Mn_{d}GₑO₂ (where 0.90≦a≦1.8, 0≦b≦0.9, 0≦c≦0.5, 0≦d≦0.5, and 0.001≦e≦0.1); LiₐNiG_{b}O₂ (where 0.90≦a≦1.8, and 0.001≦b≦0.1); LiₐCoG_{b}O₂ (where 0.90≦a≦1.8, and 0.001≦b≦0.1); LiₐMnG_{b}O₂ (where 0.90≦a≦1.8, and 0.001≦b≦0.1); LiₐMn₂G_{b}O₄ (where 0.90≦a≦1.8, and 0.001≦b≦0.1); LiQO₂; LiQS₂; LiV₂O₅; LiV₂O₅; LiI′O₂; LiNiVO₄; Li_{(3-f)}J₂(PO₄)₃ (where 0≦f≦2); Li_{(3-f)}Fe₂(PO₄)₃ (where 0≦f≦2); and LiFePO₄.

In the foregoing formulas, A is at least one selected from Ni, Co, and Mn; B′ is at least one selected from Al, Ni, Co, Mn, Cr, Fe, Mg, Sr, V, and a rare earth element; D′ is at least one selected from O, F, S, and P; E is at least one selected from Co and Mn; F′ is at least one selected from F, S, and P; G is at least one selected from Al, Cr, Mn, Fe, Mg, La, Ce, Sr, and V; Q is at least one selected from Ti, Mo, and Mn; I′ is Cr, V, Fe, Sc, and Y; and J is at least one selected from V, Cr, Mn, Co, Ni, and Cu.

The cathode active material may include, more particularly, a lithium cobalt oxide (hereinafter referred to as “LCO”), a lithium nickel oxide, a lithium nickel cobalt oxide, a lithium nickel cobalt aluminum oxide (hereinafter referred to as “NCA”), a lithium nickel cobalt manganese oxide (hereinafter referred to as “NCM”), lithium manganese oxide, lithium iron phosphate, nickel sulfate, copper sulfide, sulfur, iron oxide, or vanadium oxide. The cathode active material may be used alone or in a combination of one or more of the foregoing. The cathode active material may be contained in the cathode layer in a range of about 75 to about 99 parts by weight, based on 100 parts by weight of the cathode layer.

The cathode active material may comprise, for example, a lithium transition metal oxide having a layered rock-salt structure. The term “layered” used herein refers to a shape of a sheet, e.g., a sheet of atoms in a crystal structure of a material. The term “rock-salt structure” used herein refers to a sodium chloride type structure, which is a crystal structure and is constructed by dislocating a half of corners of a unit lattice in a face-centered cubic lattice, wherein a positive ion and a negative ion respectively form cores. The lithium transition metal oxide having the layered rock-salt structure may be, for example, a ternary lithium transition metal oxide that is represented by Li_{1-x-y-z}NiₓCo_{y}Al_{z}O₂ (NCA) or Li_{1-x-y-z}NiₓCo_{y}Mn_{z}O₂ (NCM) (where, 0<x<1, 0<y<1, 0<z<1, and x+y+z<1).

A binder may include, for example, a styrene-based thermoplastic elastomer such as styrene-butadiene rubber (SBR), butadiene rubber (BR), nitrile rubber (NMR), a styrene butadiene block copolymer (SBS), a styrene ethylene butadiene styrene block copolymer (SEB), a styrene-(styrenebutadiene)-styrene block copolymer, a natural rubber (NR), isoprene rubber (IR), or an ethylene-propylene-diene terpolymer (EPDM). The binder may be used alone or in combination.

When a solid electrolyte is used in an electrolyte layer, the solid electrolyte may be included in a cathode layer in order to increase an interface between the cathode active material and electrolyte components. The solid electrolyte may be a phosphate-based solid electrolyte or a sulfide-based solid electrolyte. The solid electrolyte may be a sulfide-based solid electrolyte since the sulfide-based solid electrolyte has high ionic conductivity.

The cathode layer may include a conducting agent, and the conducting agent may include carbon black, graphite, particulates natural graphite, artificial graphite, acetylene black, ketjen black, or carbon fibers; carbon nanotubes; a metal powder, material fibers, or metal tubes, such as copper, nickel, aluminum, and silver; and conductive polymers, such as polyphenylene derivatives, but it is not limited thereto, and any suitable material known in the art may be used.

An anode layer forming an anode structure contains an anode active material and a binder, and the anode layer is formed on a surface of an anode current collector.

The anode current collector may use a conductive material, for example, copper, stainless steel, or nickel-plated steel.

The anode active material may comprise lithium metal, a metal material alloyable with lithium, a transition metal oxide, a material capable of doping and dedoping lithium, or a material capable of reversible intercalation and deintercalation of lithium ions.

Examples of the transition metal oxide may include vanadium oxides and lithium vanadium oxides. Examples of the material capable of doping or dedoping with lithium may include Si, SiOₓ (where, 0<x<2), a Si—Y′ alloy (where, Y′ is an alkali metal, alkaline earth metal, elements of Group 13 to Group 16, transition metal, rare earth element, or a combination thereof, except that Y′ is not Si), Sn, SnO₂, Sn—Y′ (where, Y′ is an alkali metal, alkaline earth metal, of Group 13 to Group 16, a transition metal, a rare earth element, or a combination thereof, except that Y′ is not Sn), and a mixture of at least one of these and SiO₂. In some embodiments, Y′ may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or a combination thereof.

The material capable of reversible intercalation and deintercalation of lithium ions may include any suitable carbonaceous material, which may be a carbonaceous negative active material generally used in a lithium ion secondary battery, and representative examples thereof include crystalline carbon, amorphous carbon, or a combination thereof. Examples of the crystalline carbon include graphite, such as amorphous, plate-shaped, flake, spherical, or fibrous natural graphite or artificial graphite. Examples of the amorphous carbon include soft carbon (low temperature calcined carbon) or hard carbon, mesophase pitch carbide, and calcined coke.

The anode active material may include, for example, artificial graphite, natural graphite, a mixture of artificial graphite and natural graphite, a graphite active material such as natural graphite coated with artificial graphite, silicon, tin, or particulate of oxides thereof and a mixture with the graphite active material, particulate of silicon or tin, an alloy having silicon or tin as a basic material, or titanium oxide-based compounds such as Li₃Ti₅O₁₂.

A binder may include the same binder used in the cathode layer. If desired, a conducting agent may also be the same conducting agent used in the cathode layer.

The anode structure and an electrode current collector tab forming the anode structure may be manufactured using copper, aluminum, or nickel, and a part of the anode structure and the electrode current collector tab may be coupled to an electrode current collector tab coupling region of an electrode structure. A coupling method may be, for example, resistance welding, or ultrasonic welding.

An electrolyte layer may include a solid electrolyte. The electrolyte layer may also include a known aqueous electrolyte, a non-aqueous electrolyte, ionic liquid, or a polymer gel electrolyte. The solid electrolyte may include, for example, a sulfide-based solid electrolyte, oxide-based solid electrolyte, or phosphate-based solid electrolyte.

The solid electrolyte may include a sulfide-based compound. The sulfide-based solid electrolyte may be used due to high ionic conductivity thereof. The solid electrolyte may have a high ionic conductivity, in particular, the ionic conductivity may be 10⁻⁵ Siemens per centimeter (S/cm) or more, or, for example, 10⁻⁴ S/cm or more.

The solid electrolyte may be an amorphous crystalloid.

The sulfide-based compound may be a sulfide compound including lithium (Li), phosphate (P), and sulfur (S). For example, the sulfide-based compound may include Li₇P₃S₁₁, Li₃PS₄, Li₇PS₆, or Li₆PS₅CI.

The ionic conductivity of the solid electrolyte depends on a particle diameter and a specific surface area. Therefore, the solid electrolyte may be, for example, the sulfide-based compound having an average particle diameter in a range of about 0.1 μm to about 100 μm, for example, in a range of about 5 μm to about 50 μm. The average particle diameter of the solid electrolyte may be obtained by measuring particle diameters of fifty randomly selected particles of the solid electrolyte by using a dry particle-size distribution measuring apparatus and then calculating an average value of the measurement results.

The solid electrolyte, for example, the sulfide-based compound may have a specific surface area of at least about 0.1 square meters per gram (m²/g), for example, at least about 1 m²/g. When the specific surface area of the solid electrolyte is large, an area of the interface between the solid electrolyte and the electrode active material may increase. Ion conduction path also may be improved. The specific surface area of the solid electrolyte may be measured by using a specific surface area measuring instrument. In addition, a solid electrolyte layer may include a known binder noted above in addition to the solid electrolyte.

The exterior body may be molded using a flexible, liquid-impermeable, and air-impermeable material having flexibility, liquid tightness, and airtightness. Being provided with “flexibility” refers to a property of bending by an external force. Being provided with “liquid tightness” refers to a property of having liquid impermeability. Being provided with “airtightness” refers to a property of having air impermeability. The exterior body may be molded in any suitable shape, which may encapsulate a cell composed of a first electrode structure, an electrolyte layer, and a second electrode structure by having flexibility. The exterior body may suppress contact between the cell and the outside air and prevent leaking of components of encapsulated cell by having liquid tightness and airtightness.

The exterior body may be molded using a membrane formed of a thermal compressible resin that is deposited on a surface of a metal material. Examples of the exterior body may be a membrane formed of the thermal compressible resin that is deposited on a surface of aluminum or stainless steel. The thermal compressible resin may be a polyolefin resin such as polypropylene or polyethylene and a polyester resin having heat resistance. A sheet or film formed of the membrane formed of the thermal compressible resin may be used as the exterior body by molding the sheet or film in a shape that may encapsulate the cell composed of an electrode structure and an electrolyte layer.

The pressure treatment may be a hydrostatic pressure treatment. By performing a hydrostatic pressure treatment, the cell enclosed with the exterior body may be pressed and compacted in every direction. A secondary battery according to an embodiment may have an electrode current collector and an electrode current collector tab coupling region supported in two directions that are parallel with a surface direction. Thus, even when a hydrostatic pressure treatment is performed, the electrode current collector tab coupling region (in an electrode layer non-forming region of the electrode current collector) may prevented from being fractured.

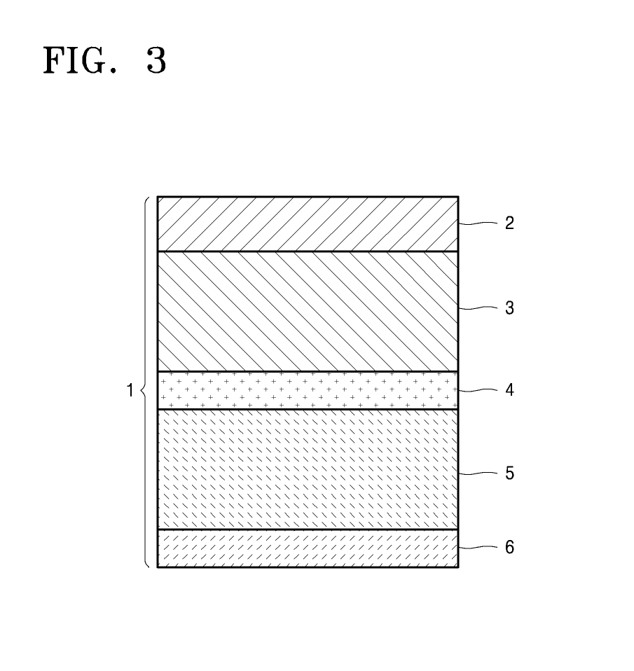

Shown in FIG. 3 is a schematic cross-sectional view of an all solid battery according to another embodiment.

An all solid battery 1 according to an embodiment may include a second electrode layer (e.g., an anode layer) 5 on a second electrode current collector (an anode current collector) 6, a first electrode layer (e.g., a cathode layer) 3 on a first electrode current collector (e.g., a cathode current collector) 2, and a solid electrolyte layer 4 disposed between the first electrode layer (e.g., the cathode layer) 3 and the second electrode layer (e.g., the anode layer) 5. Descriptions for the second electrode current collector (e.g., the anode current collector), the second electrode layer (e.g., the anode layer), the first electrode current collector (e.g., the cathode current collector), the first electrode layer (e.g., the cathode layer), and the solid electrolyte layer are the same as the descriptions provided above, and thus are not repeated for clarity.

### Method of Manufacturing Lithium Ion Secondary Battery

According to another aspect, a method of manufacturing a secondary battery may include coating a surface of a first electrode current collector and a second electrode current collector, respectively, with an electrode coating solution including a first electrode active material and a second electrode active material to form a first electrode layer, a second electrode layer, and an electrode layer non-forming region including an electrode current collector tab coupling region in an interior of the first electrode layer and the second electrode layer, respectively; coupling the electrode current collector tab coupling region to an electrode current collector tab to manufacture a first electrode structure and a second electrode structure; and disposing an electrolyte layer between the first electrode structure and the second electrode structure, and enclosing the first electrode structure, the second electrode structure, and the electrolyte layer in an exterior body, and then integrating the first electrode structure, the second electrode structure, and the electrolyte layer by performing a pressure treatment to manufacture a secondary battery.

### Forming First Electrode Layer, Second Electrode Layer, and Electrode Layer Non-Forming Region Including Electrode Current Collector Tab Coupling Region in Interior of First Electrode Layer and Second Electrode Layer

A first electrode layer and a second electrode layer may be a cathode layer and an anode layer, respectively, or vice versa. Hereinafter, for convenience, the first electrode layer will be referred to as a cathode layer, and forming a cathode layer and a cathode layer non-forming region including a cathode current collector tab coupling portion in an interior of the cathode layer will be described. However, a process that will be described hereinafter may also be applied to a process referring the second electrode layer as an anode layer, and forming an anode layer and an anode layer non-forming region including an anode current collector tab coupling portion in an interior of the anode layer.

Firstly, as for electrode coating solution, a cathode coating solution may be manufactured in advance by adding a cathode active material, a solid electrolyte, and a binder to a solvent. The solvent of the cathode coating solution may be selected from non-polar solvents. Particularly, examples of the non-polar solvents include aromatic hydrocarbons such as toluene, xylene, or ethylbenzene, or aliphatic hydrocarbons such as pentane, hexane, or heptane.

A surface of a cathode current collector may be coated with obtained cathode coating solution, and then the obtained cathode coating solution was dried to remove a solvent, thereby forming a cathode layer. The cathode layer may have a thickness in a range of about 150 μm to about 350 μm. Coating of the cathode coating solution may be performed on a predetermined portion of the cathode layer forming region, and cathode current collector tab coupling portion may not be coated with the cathode coating solution. A method of coating the cathode coating solution on a predetermined portion of the cathode layer forming region may be, for example, a method of coating the cathode coating solution by using a screen printing after masking with a metal mask having a notch in a part corresponding to the cathode current collector tab coupling portion and a method of coating by using a die coater or a doctor blade. Thus, the cathode layer and the cathode layer non-forming region including the cathode current collector tab coupling portion may be formed at the same time.

### Manufacturing First Electrode Structure and Second Electrode Structure

The cathode current collector tab coupling portion may be allowed to overlap with one end of the cathode current collector tab so as to mount another end to protrude outside of a current collector, and then cathode current collector tab coupling portion and cathode current collector tab may be coupled, thereby manufacturing a first electrode structure or an cathode structure. A coupling area may be in a range of about 0.15 square centimeters (cm²) to about 1.00 cm², for example, in a range of about 0.20 cm² to about 0.25 cm². A coupling method may be resistance welding, or ultrasonic welding. After coupling, an overlapped part of the cathode current collector tab and the cathode current collector tab coupling portion may be supported by the cathode layer in two or more directions that are parallel with a surface direction of the current collector. Thus, even when the battery is pressed in a post manufacture process, the cathode current collector tab coupling portion may not be fractured.

The method of manufacturing may also be applied to a second electrode structure or an anode structure. When manufacturing an anode structure, an anode active material and a binder may be added to a polar solvent such as N′-methylpyrrolidone to manufacture an anode coating solution. By coating a predetermined portion of the anode current collector, the anode layer and the anode current collector tab coupling portion may be formed. A method of forming the anode layer and the anode current collector tab coupling portion may be the same with a method of forming the cathode layer and the cathode current collector tab coupling portion.

### Manufacturing Secondary Battery

### Manufacturing Process of Electrolyte Layer

When a solid electrolyte layer is manufactured using a solid electrolyte, firstly, a predetermined solid electrolyte and a binder may be added to non-polar solvents such as aromatic hydrocarbons such as xylene, toluene, or ethylbenzene, or aliphatic hydrocarbons including pentane, hexane, or heptane in order to manufacture the solid electrolyte coating solution. An anode layer forming surface of the second electrode structure or the anode structure may be coated with obtained solid electrolyte coating solution, and then dried to remove a solvent, thereby manufacturing the solid electrolyte layer. For example, a thickness of the solid electrolyte layer may have a thickness with a range of about 75 μm to about 200 μm.

Another method of manufacturing the electrolyte layer may be directly forming the electrolyte layer on a film, and drying and detaching the electrolyte layer from the film, thereby obtaining a solid electrolyte single membrane.

### Assembling Process

During an assembling process, a cell composed of the first electrode structure or cathode structure, the electrolyte layer, and the second electrode structure or anode structure may be enclosed with using a predetermined exterior body while exposing a part of a first electrode current collector tab or cathode current collector tab and a part of a second electrode current collector tab or anode current collector tab. A method of enclosing may be, for example, encapsulating the cell in an exterior body formed in a shape of a pouch and sealing an opening by thermal compression after vacuum degassing. A method of molding the exterior body in a shape of the pouch may include folding the exterior body in a shape of one sheet and thermal compressing an open side of the folded sheet; or placing two sheets of the exterior body and thermal compressing three sides of the sheets.

The cell used in one embodiment does not have a protruding portion, and thus the usage amount of the exterior body which is used to encapsulate the cell may be suppressed. Thus, energy density of the secondary battery, for example, energy density of lithium ion secondary battery may be improved. Manufacturing cost may also be reduced.

The cell enclosed with the exterior body may be integrated by performing a pressure treatment thereto. The pressure treatment may be performed under a pressure in a range of about 294 megapascals (MPa) to about 980 MPa for about 30 seconds to about 20 minutes. For example, the pressure treatment may be performed under a pressure in a range of about 490 MPa to about 980 MPa for about 5 minutes to about 10 minutes. The electrode current collector tab coupling region may be supported by an electrode layer forming region in two or more directions that are parallel with a surface direction. As a result, the electrode current collector tab coupling region may not be damaged even when the battery is pressed under a condition of the pressure treatment. Therefore, manufacturing efficiency of the secondary battery is excellent. When a condition of the pressure treatment is lower than a lower limit of the above described range, pressurizing may not be performed enough and coupling between particles may not be sufficiently obtained. Thus, excellent battery characteristics may not be obtained. In addition, when a condition of the pressure treatment is upper than an upper limit of the above described range, additional electrode density may not be obtained. Also, facility cost may increase.

A method of pressurizing may be using a hydrostatic pressure press. When applying a hydrostatic pressure treatment, the cell and the exterior body may be equally pressurized in every direction. Therefore, even when an electrode with a small area difference between the first electrode layer or cathode layer and the second electrode layer or anode layer is used, ingredients of each of an electrode layer and a solid electrolyte layer may be homogeneously compacted at a high pressure without a short-cut occurring at an edge portion. Accordingly, energy density of the secondary battery may be improved. An effect of preventing the electrode current collector tab from being fractured may be achieved especially when applying a hydrostatic pressure treatment.

An embodiment will now be described in further detail with reference to the following Example and Comparative Example. However, these examples are illustrative purposes only and shall not limit the scope of the disclosed embodiment.

### Example

### Manufacture of Second Electrode Structure or Anode Structure

A graphite powder as an anode active material (vacuum dried at 80° C. for 24 hours), and acid-modified polyvinylidene fluoride (PVdF) as a binder were weighed at a weight ratio of 96.5:3.5. A graphite powder, acid-modified PVdF, and an appropriate amount of N-Methylpyrrolidone (NMP) were charged in a planetary mixer, followed by stirring at 3000 rpm for three minutes and defoaming for one minute to manufacture an anode layer coating solution.

A copper foil current collector which was cut in a size of 12 cm×18 cm and having a thickness of 12 μm was prepared as an anode current collector. The anode layer coating solution was coated on the copper foil current collector by using a blade. In order to form one end of an anode current collector tab coupling portion in a size of 0.8 cm×1 cm to be overlapped with one end of the copper foil current collector, a mask having a notch was mounted on the copper foil current collector when coating. As a result, notch part was not coated with the anode coating solution. A thickness (gap) of the anode layer coating solution on the copper foil current collector was about 150 μm.

The anode current collector coated with the anode layer coating solution was accommodated in a dryer that has been heated to maintain 80° C., and then was dried for 20 minutes. An anode layer and an anode current collector tab coupling portion were formed on the anode current collector thereafter. The anode current collector tab coupling portion was formed while being supported by the anode layer forming portion of the current collector in three directions that are parallel with a surface direction of the current collector. The anode current collector was rolled by using a roll press having a roll gap of 10 μm. The anode current collector tab coupling portion was coupled to the anode current collector tab in a size of 0.5 cm×3 cm by using ultrasonic welding. Thus an anode structure coupled to the anode current collector tab was manufactured. A thickness of an obtained anode structure was about 100 μm. A coupled part of the anode current collector tab was supported by the anode layer in three directions that are parallel with the surface direction. After rolling, the anode structure was vacuum heated at 100° C. for 12 hours.

### Manufacture of First Electrode Structure or Cathode Structure

A LiNiCoAlO₂ ternary-based powder as a cathode active material, Li₂S—P₂S₅ (80:20 mol %) as a sulfide-based solid electrolyte, and a vapor grown carbon fiber powder as a cathode layer conductive material (a conducting agent) were weighed at a weight ratio of 60:35:5 and mixed by using a planetary mixer to obtain a mixture powder.

A xylene solution dissolving a styrene-based thermoplastic elastomer, which was used as a cathode layer binder, was added to the mixture powder, with an amount of the styrene-based thermoplastic elastomer being 1.0 wt % based on the total weight of the mixture powder in order to provide a primary mixture solution. In addition, a predetermined amount of dehydrated xylene was added to adjust viscosity of the primary mixture solution, thereby producing a secondary mixture solution. Then, in order to increase dispersibility of the mixture powder, zirconia balls having a diameter of 5 mm were inserted into a secondary mixture solution such that each of an empty space, the mixture powder, and zirconia balls occupies one-third of the total volume of a mixing vessel. Thus, a tertiary mixture solution was produced and was stirred at a rotational speed of 3000 rpm for 3 minutes in the planetary mixer, thereby producing a cathode layer coating solution.

Subsequently, the cathode current collector was mounted on a tabletop screen printing machine. In order to form one end of cathode current collector tab coupling portion in a size of 0.6 cm×0.8 cm on a surface of the cathode current collector to overlap one end of the cathode current collector, the cathode current collector was coated with the cathode layer coating solution by using a metal mask having a notch that has a thickness of 150 μm. Afterward, the cathode current collector that is coated with the cathode layer coating solution was dried at 40° C. for 10 minutes on a hot plate, and then was vacuum-dried at 40° C. for 12 hours. As a result, a cathode layer and the cathode current collector tab coupling portion were formed. The cathode current collector tab coupling portion was formed while being supported by a cathode layer forming region of the cathode current collector in three directions that are parallel with a surface direction. The cathode current collector tab coupling portion was coupled with a cathode current collector tab in a size of 0.5 cm×3 cm by using ultrasonic welding. After drying the cathode current collector and the cathode layer, the total thickness of the cathode current collector and the cathode layer was about 165 μm. A coupling part of the cathode current collector tab was supported by the cathode layer in three directions that are parallel with the surface direction.

### Formation of Electrolyte Layer

A xylene solution dissolving a styrene-based thermoplastic elastomer, which was used as an electrolyte binder, was added to Li₂S—P₂S₅ (80:20 mol %) amorphous powder as a sulfide-based solid electrolyte with an amount of the styrene-based thermoplastic elastomer being 1 wt % with respect to the total weight of a solid electrolyte powder in order to provide a primary mixture solution. In addition, a predetermined amount of dehydrated xylene was added to adjust viscosity of the primary mixture solution, thereby producing a secondary mixture solution. Then, in order to increase dispersibility of the mixture powder, zirconia balls having a diameter of 5 mm were inserted into a secondary mixture solution such that each of an empty space, the mixture powder, and the zirconia balls occupies one-third of the total volume of a mixing vessel. Thus, a tertiary mixture solution was produced and was stirred at a rotational speed of 3000 rpm for 3 minutes in the planetary mixer, thereby manufacturing an electrolyte layer coating solution.

Subsequently, the anode current collector was mounted on the tabletop screen printing machine. An anode structure was coated with the electrolyte layer coating solution by using a metal mask having a thickness of 100 μm. The metal mask that was used had a notch at the same location as the metal mask used in forming the anode structure. Afterward, a sheet was coated with the electrolyte layer coating solution was dried at 40° C. for 10 minutes on the hot plate, and then was vacuum-dried at 40° C. for 12 hours. As a result, an electrolyte layer was formed on an anode structure. After drying the electrolyte layer, a thickness of the electrolyte layer was about 130 μm.

### Manufacture of Secondary Battery

The second electrode structure or anode structure, the electrolyte layer, and the first electrode structure or cathode structure were each tapped with a Thomson blade. The second electrode structure or anode structure, the electrolyte layer, and the first electrode structure or cathode structure were stacked and placed in an aluminum laminate film that is in a shape of a pouch, and then were vacuum-degassed, and then were packed by heat-sealing. Thereafter, the aluminum laminate film pack was pressed by using a hydrostatic pressure press under a pressure of 490 MPa for 10 minutes to couple each other. A lithium ion secondary battery having the same structure as the secondary battery of FIG. 1B was manufactured.

A hydrostatic pressure treatment was performed on the electrode current collector tab coupling region, which is shown in FIG. 1B, and then, the presence of a fracture was inspected, however, a fracture of the first electrode current collector tab coupling region or the cathode current collector tab coupling portion and the second electrode current collector tab coupling region or the anode current collector tab coupling portion was not observed with a naked eye.

### Comparative Example

A first electrode layer or a cathode layer, a second electrode layer or an anode layer, and a solid electrolyte layer were formed by using the same material as in Example and a metal mask without a notch. A first electrode structure or a cathode structure and a second electrode structure or an anode structure were manufactured, and an electrode current collector thereof has been coupled to an electrode current collector tab, respectively. Also, a solid electrolyte layer was manufactured. A lithium ion secondary battery having the same structure with the first electrode structure or cathode structure and second electrode structure or anode structure of the secondary battery of FIG. 2B was manufactured.

As shown in FIG. 2B, the electrode current collector and an electrode current collector tab coupling portion each protrudes from an electrode layer forming region, and the electrode current collector tab coupling region was supported by the electrode layer forming region of the electrode current collector in one direction that are parallel with a surface direction.

The first electrode layer or cathode layer, the solid electrolyte layer, and the second electrode layer or anode layer were stacked and enclosed with an exterior body. Thereafter, the exterior body was pressed by using a hydrostatic pressure press under a pressure of 490 MPa for 10 minutes. However, when pressing the exterior body, the electrode current collector tab coupling region, a cathode, and an anode were fractured. Since, the electrode current collector tab coupling region, the cathode, and the anode were fractured; an electrode current collector tab, which is fractured, was re-welded, thereby manufacturing a lithium ion secondary battery.

### Energy Density Measurement Evaluation

A weight and a volume of the exterior body of the lithium ion secondary batteries prepared in Example and Comparative Example were each measured, and energy density was measured at the same time to evaluate by using a method described below. That is, discharge capacity and average discharge voltage were measured by using a known method, and the weight and the volume of the batteries were measured at the same time. Based on the measured result, a weight energy density and a volume energy density were calculated. The result of evaluation is shown in Table 1 below.

TABLE 1

| | | Comparative |
|---|---|---|
| | Example | Example |
| Weight of exterior body | 3.340 | 3.712 |
| (g) | | |
| Weight energy density | 173 | 156 |
| (Wh/kg) | | |
| Volume of exterior body | 1.728 | 1.872 |
| (cm³) | | |
| Volume energy density | 343 | 333 |
| (Wh/L) | | |

As noted in Table 1 above, a weight energy density of the battery of Example was 173 Watt-hours per kilogram (Wh/kg), and a volume energy density thereof was 343 Watt-hours per liter (Wh/L). The weight energy density of Comparative Example was 156 Wh/kg, and the volume energy density of Comparative Example was 333 Wh/L. In another embodiment, a weight energy density of a lithium ion secondary battery manufactured in the same manner as in Example was 175 Wh/kg. Therefore, it was confirmed that the weight energy density and the volume energy density of Example were improved compared to the weight energy density and the volume energy density of Comparative Example.

As described above, according to the disclosed embodiment, the secondary battery may have an electrode current collector tab coupling portion that is prevented from being fractured, so as to increase manufacturing efficiency. In addition, a volume of a cell of the secondary battery composed of a first electrode structure, an electrolyte layer, and a second electrode structure may be decreased, thereby decreasing a usage amount of an exterior body enclosing the cell. Thus, the energy density of the secondary battery may be improved.

It should be understood that the exemplary embodiments described therein should be considered in a descriptive sense only and not for purposes of limitation. Descriptions of features, advantages, or aspects within each exemplary embodiment should typically be considered as available for other similar features, advantages, or aspects in other exemplary embodiments.

While one or more embodiments have been described with reference to the figures, it will be understood by those of ordinary skill in the art that various changes in form and details may be made therein without departing from the spirit and scope as defined by the following claims.

What is claimed is:

1. A secondary battery comprising:
a first electrode structure comprising a first electrode current collector, the first electrode current collector comprising a first electrode layer forming region and a first electrode layer non-forming region on each surface of the first electrode current collector,
a second electrode structure comprising a second electrode current collector, the second electrode current collector comprising a second electrode layer forming region and a second electrode layer non-forming region on each surface of the second electrode current collector,
wherein the first and second electrode layer non-forming regions respectively comprise first and second electrode current collector tab coupling regions in an interior portion of each of the first and second electrode layer forming regions, and
wherein the first electrode structure, the second electrode structure, and an electrolyte layer are disposed between the first electrode structure and the second electrode structure and are disposed in an exterior body.

2. The secondary battery of claim 1, wherein the first and second electrode current collector tab coupling regions are located in an outermost portion of the first and second electrode layer forming regions, respectively.

3. The secondary battery of claim 1, wherein the first and second electrode current collector tab coupling regions each have a shape of a circle or polygon.

4. The secondary battery of claim 1, wherein an outer portion of each of the first and second electrode current collector tab coupling regions is connected to the first and second electrode layer forming regions, respectively, in two or more directions that are parallel with a surface direction.

5. The secondary battery of claim 3, wherein the first and second electrode current collector tab coupling regions each has a shape of a rectangle, and
wherein an outer portion of the first and second electrode current collector tab coupling regions is connected to the first and second electrode layer forming regions, respectively, in three directions that are parallel with a surface direction.

6. The secondary battery of claim 1, further comprising first and second electrode current collector tabs, wherein the first and second electrode current collector tabs are coupled to the first and second electrode current collector tab coupling regions, respectively, and an end of each of the first and second electrode current collector tabs protrudes from the first and second electrode current collectors, respectively.

7. The secondary battery of claim 1, wherein an area of each of the first and second electrode current collector tab coupling regions is in a range of about 0.8% to about 1.3%, with respect to a total area of the electrode current collector.

8. The secondary battery of claim 1, wherein the first and second electrode structures do not comprise a protruding portion.

9. The secondary battery of claim 1, wherein the electrolyte layer comprises a solid electrolyte.

10. The secondary battery of claim 9, wherein the solid electrolyte comprises a sulfide compound.

11. The secondary battery of claim 10, wherein the sulfide compound comprises Li₇P₃S₁₁, Li₃PS₄, Li₇PS₆, or Li₆PS₅Cl.

12. The secondary battery of claim 10, wherein the sulfide compound has an average particle diameter in a range of about 0.1 micrometer to about 100 micrometers.

13. The secondary battery of claim 10, wherein the sulfide compound has a specific surface area of at least about 0.1 square meters per gram.

14. The secondary battery of claim 1, wherein the exterior body comprises a flexible, liquid-impermeable, and air-impermeable material.

15. The secondary battery of claim 1, wherein the exterior body comprises a membrane comprising a thermally compressible resin that is disposed on a surface of a metallic material.

16. The secondary battery of claim 1, wherein the first electrode structure and the second electrode structure are a product of hydrostatic pressure treatment.

17. A method of manufacturing a secondary battery, the method comprising:
coating a surface of a first electrode current collector with a first electrode coating solution comprising a first electrode active material to form a first electrode layer and a first electrode layer non-forming region comprising a first electrode current collector tab coupling region in an interior of the first electrode layer;
coating a surface of a second electrode current collector with a second electrode coating solution comprising a second electrode active material to form a second electrode layer and a second electrode layer non-forming region comprising a second electrode current collector tab coupling region in an interior of the second electrode layer;
coupling the first and second electrode current collector tab coupling regions to first and second electrode current collector tabs, respectively, to manufacture a first electrode structure and a second electrode structure;
disposing an electrolyte layer between the first electrode structure and the second electrode structure;
enclosing the first electrode structure, the second electrode structure, and the electrolyte layer with an exterior body; and then
pressure treating the first electrode structure, the second electrode structure, and the electrolyte layer to integrate the first electrode structure, the second electrode structure, and the electrolyte layer to manufacture the secondary battery.

18. The method of claim 17, wherein the first and second electrode current collector tab coupling regions are formed on the first and second electrode layer non-forming regions, respectively, in an interior of the first electrode layer and the second electrode layer, respectively.

19. The method of claim 17, wherein the pressure treatment is a hydrostatic pressure treatment.

20. The method of claim 17, wherein the pressure treatment is performed under a pressure in a range of about 294 megapascals to about 980 megapascals for about 30 seconds to about 20 minutes.
